(19) United States
(12) Patent Application Publication
(10) Pub. No.: US 2007/0123607 A1
(43) Pub. Date: May 31, 2007

(54) Environmental-friendly inkjet ink composition

(75) Inventors: Ke-Yung King, Hsinchu City (TW); Chia-Kuei Ling, Hsinchu City (TW); Yi-Ching Lu, Hsinchu City (TW)

Correspondence Address: BIRCH STEWART KOLASCH & BIRCH, PO BOX 747, FALLS CHURCH, VA, 22040-0747, US

(73) Assignee: JETQ CORPORATION

(21) Appl. No.: 11/370,850

(22) Filed: Mar. 9, 2006

(30) Foreign Application Priority Data
Nov. 30, 2005 (TW) 094142091

(51) Int. Cl. C09D 11/00

(52) U.S. Cl. 523/160; 524/366

(57) ABSTRACT

There is provided an environmental-friendly inkjet ink composition, comprising an organic solvent, a pigment or a dye, a surfactant, a dispersant, and a wetting agent. The low-toxic, non-pungent, and high-boiling polyethylene glycol ether solvent, the fruit smelling acetoacetate solvent, the food grade resin, and the non-harmful additives containing silicon are used in the inkjet ink composition. Such an inkjet ink composition has excellent humectancy, high printing resolution, and has very good adhesion to a wide variety of substrates when applied in printing. Also, the inkjet ink composition is non-pungent, environmental-friendly and found no harmful to human bodies.

### BACKGROUND OF THE INVENTION

1. Field of the Invention

The present invention generally relates to an inkjet ink composition, and in particular to an environmental-friendly inkjet ink composition which can meet high-resolution printing needs and have very good adhesion to a wide variety of substrates, and the basic components in the inkjet ink composition are environmental-friendly and found no harmful to human bodies.

2. The Prior Arts

All the ink jet printers use the printheads with nozzles to create ink drops. But there are two fundamentally different kinds of printhead technology: thermal bubble type, and piezo type. The piezo printheads can be further classified into high-precision ones, such as Epson printhead, and low-precision ones, such as Xaar and Spectra printhead. The thermal bubble printheads use the water-soluble pigment or dye, and the piezo printheads use the solvent pigment.

The solvent inks are used to be printed onto the large outdoor advertising boards. The organic solvents used in the solvent inks are usually very corrosive, and are able to penetrate in the uncoated canvases, and thereby these solvent inks have good adhesion to the canvases. Furthermore, if the resins are added into the ink, the printed pattern will have excellent rub resistance and scratch resistance. The costs for the solvent inks are low, and they can be put outdoors for 1 to 3 years. Therefore, the solvent inks are the preferred choice for the mass-produced printed advertisements. The corrosive solvents which are harmful to the human body, such as cyclohexanone, 2-ethoxyethyl acetate, isophorone, methyl isobutyl ketone (MIBK), are usually used in the solvent inks to increase the pattern resolution and the selectivity of the printing materials. These corrosive solvents can help the ink easily stick to the uncoated substrate, and also the costs of these corrosive solvents are low. However, there are many health and safety considerations with these corrosive solvents used in the solvent inks. Most of them are extremely toxic if inhaled in a large amount. Additionally, animal testing with these corrosive solvents has shown some evidence of carcinogenicity.

### SUMMARY OF THE INVENTION

The objective of the present invention is to provide an inkjet ink composition in which the basic components are environmental-friendly, and found no harmful to human bodies and livestocks, and the inkjet ink composition provides high printing resolution and good adhesion to various kinds of printing substrates, such as polyvinyl chloride (PVC), in order to overcome the problems set forth above.

To achieve the foregoing objective, the present invention provides an inkjet ink composition, comprising at least one pigment, at least one surfactant, at least one high-boiling polyethylene glycol ether solvent, at least one acetoacetate solvent, and at least one resin. The high-boiling polyethylene glycol ether solvent used in the inkjet ink composition of the present invention has a formula of R₁—O(CH₂CH₂O)ₙ—R₂, where R₁ and R₂ are each independently alkyl groups having 1 to 4 carbon atoms, and n is an integer from 2 to 5. Examples of the high-boiling polyethylene glycol ether solvents include, but are not limited to, diethylene glycol dibutyl ether, diethylene glycol diethyl ether, diethylene glycol ethyl methyl ether, diethylene glycol dimethyl ether, triethylene glycol dimethyl ether, and tetraethylene glycol dimethyl ether. The polyethylene glycol ether solvents provide excellent humectancy and they can prevent the nozzles on the printhead from clogging. The acetoacetate solvent used in the inkjet ink composition of the present invention has a formula of CH₃COCH₂COOR₃ where R₃ is alkyl group having 1 to 4 carbon atoms. Examples of the acetoacetate solvents include, but are not limited to, butyl acetoacetate, ethyl acetoacetate, isopropyl acetoacetate, methyl acetoacetate, and propyl acetoacetate. The acetoacetate solvent can modify the penetrating power of the ink, and enhance the printing resolution. The resins used in the inkjet ink composition of the present invention include vinyl polymers, such as UCAR™ solution vinyl resins under several trade names: UCAR VYHH, VYNS-3, VYNC-P, VMCH, VAGD, VAGF, VAGC, VAGH, VYLF-X, VROH, VERR-40, and VMCA, manufactured by Dow Chemical Company. The resins used in the inkjet ink composition of the present invention can enhance the ink adhesion to the substrate, and improve the scratch resistance and the coloration of the resulting image. Examples of the wetting agents/leveling agents containing silicon used in the inkjet ink composition of the present invention include polyether siloxane copolymer in TEGO® WET series, manufactured by TEGO Corp.; GE silicones in Coatosil® series, manufactured by Crompton Corp; EFKA®-73 leveling agents which contains silicon, manufactured by EFKA Corp.; and Perenol® series leveling agents not containing silicon, manufactured by Henkel Corp. Such wetting agents can reduce the surface tension of the ink, allowing better coverage on the printing substrate, and can improve the adhesion to a printing substrate without the defect of shrinkage holes, so the printing quality is improved.

The foregoing and other objectives, features, aspects and advantages of the present invention will become better understood from a careful reading of a detailed description provided herein below.

### DETAILED DESCRIPTION OF THE PREFERRED EMBODIMENT

The present invention provides an environmental-friendly inkjet ink composition, comprising at least one pigment, at least one surfactant, at least one polyethylene glycol ether solvent, at least one acetoacetate solvent, and at least one resin.

In the inkjet ink composition of the present invention, the pigment is present in an amount of from 1 to 40% by weight of the total weight of the inkjet ink composition, the surfactant is present in an amount of from 0.1 to 1.0% by weight of the total weight of the inkjet ink composition, the polyethylene glycol ether solvent is present in an amount of from 30 to 60% by weight of the total weight of the inkjet ink composition, the acetoacetate solvent is present in an amount of from 20 to 40% by weight of the total weight of the inkjet ink composition, and the resin is present in an amount of from 0.5 to 10% by weight of the total weight of the inkjet ink composition. The viscosity of the inkjet ink composition is in the range of 3.0 to 20 cps at ambient temperature, and the surface tension of the inkjet ink composition is in the range of 20 dynes/cm to 40 dynes/cm.

The basic components in the inkjet ink composition of the present invention comprises a colorant, a solvent, a wetting agent, a resin, a surfactant, and other additives. The solvent is usually present in an amount of from 65 to 90% by weight of the total weight of the inkjet ink composition. The most common solvents used in an ink composition is ketones, such as cyclohexanone, 2-ethoxyethyl acetate, isophorone, methyl isobutyl ketone (MIBK). These ketones are volatile, and corrosive to the materials, but these ketones can help the colorants easily stick to the printing substrate, and also they are cheap. However, the drawbacks of these ketones are that their odor are very pungent, and they are harmful to human bodies and livestocks. The toxicological information provided by the material safety data sheet shows these ketones are carcinogens, and highly toxic to the environment. Therefore, the acetoacetates, which are environmental-friendly and found no harmful to human bodies and livestocks, are used in the inkjet ink composition of the present invention. The acetoacetates can meet the requirements of the printing quality. Although the acetoacetates are as corrosive as the ketones, they have a fruity odor instead of a pungent odor as the ketones. Furthermore, the acetoacetates are not carcinogens, and they are biodegradable. These acetoacetates even can be applied in food as an additive.

With respect to the colorants, the colorants used in the inkjet ink composition of the present invention have good waterfastness and lightfastness, and the amount of colorants used is typically from 1.0 to 30% by weight based on the total weight of the inkjet ink composition. If the colorant particle sizes are in the range of 0.05 to 0.5 μm, the ink composition will have the best color gamut, high optical density, covering capabilities, and lightfastness. The pigments can not be dissolved in the solvents, but can be evenly dispersed in the solvents, and thereby the suitable wetting and dispersing additives must be added during the milling process so that the pigment can be evenly dispersed in the solvent. The dispersing additives are commonly added to the pigment dispersion to facilitate the deaggregation of the raw pigment, to maintain colloidal particle stability, and to retard particle reagglomeration through van der Waals force and settling. If the pigment particles are brought together by van der Waals force and form larger agglomerates which can be observed by the naked eyes the problems of the non-uniform coloring and the clogging of the nozzles will happen. The electrostatic and steric mechanisms contribute to the development of stabilized pigment dispersions. The electrostatic stabilization is dependent upon the formation of a repulsive charged double layer potential. A charge is generated on the pigment surface, and a more diffuse cloud of oppositely charged ions develops around it. As two pigment particles approach each other the charge effectively provides a barrier to closer particle interactions to prevent the pigment particles from agglomerating. On the other hand, the steric stabilization relies on the adsorption of polymeric dispersant on the surface of the pigment. One end of the polymeric dispersant is successfully anchored to the pigment surface, and another end is extended into the mixture of the resin and the solvent. As the pigment particles approach each other, these adsorbed polymer chains are repelled from one another, and thereby the steric stabilization can prevent the pigment particle aggregation. In order to understand the effect of the presence of the organic solvent and the resin on the pigment dispersion, the inkjet ink composition containing the resin, the solvent, and the pigment of the present invention are kept in the thermostated bath at 45° C. to perform the accelerated test. The test results show that the pigment particles do not precipitate, and the viscosity of the inkjet ink composition vary little. Therefore, the test results prove the pigment can be evenly and stably dispersed in the inkjet ink composition of the present invention.

With respect to the wetting agent, the printhead nozzles are exposed in the ambient environment whether they are used or not used. When the solvent in the inkjet ink composition is evaporated, the dried ink residues may clog the printhead nozzles, which will cause poor printing. Therefore, a wetting agent, which is usually high boiling solvent, is added to the inkjet ink composition to help prevent the ink from drying out or crusting in the nozzle orifices of the printhead by slowing down the solvent evaporation. The wetting agent may be employed in an amount of 50% or less by weight of the total weight of the inkjet ink composition.

The glycol ethers have good solubility to various kinds of aqueous or organic solvents, and also they are able to stabilize the colorant in the ink. The glycol ethers have high boiling points, polarities, and solubilities so that they have widespread solvent applications including inks, dyes, oils and cleaners. However, overexposure to glycol ethers may cause effects including symptoms of central nervous system depression, such as drowsiness, headache, unusually fatigue, incoordination, and the like. Long-term inhalation of glycol ethers may cause anemia, bone marrow supression, brain diseases, and the like. The high boiling polyethylene glycol ethers used in the present invention are not pungent and can provide excellent humectancy to prevent the nozzles of the printhead from clogging besides they have the above-mentioned advantages. Such polyethylene glycol ethers are corrosive to the PVC substrates. An instant adhesion between the ink and the printing substrate is accelerated when the printing substrates are preheated during printing, and thereby the ink diffusion is alleviated, so the resolution printing resolution is increased, and the printing quality is enhanced. These polyethylene glycol ethers can be used both as a wetting agent and as a solvent. The toxicological information provided by the material safety data sheet shows these polyethylene glycol ethers are not carcinogens, and are low toxic to human bodies and livestocks, and thereby the safety are greatly enhanced by using these polyethylene glycol ethers.

With respect to the resins, the resins in the inkjet ink composition of the present invention are used to adjust the viscosity of the inkjet ink composition, and the amount of resins used is 10% or less by weight based on the total weight of the inkjet ink composition. The resins used in the present invention can meet the specification of the printhead, and also can improve scratch resistance, waterfastness, brightness, and weather resistance of the inkjet ink composition. There are various kinds of commercially available resins. The resins used in the inkjet ink composition of the present invention include UCAR™ solution vinyl resins available from Dow Chemical Company. UCAR™ solution vinyl resins are FDA approved for use in food-contact applications, and have a molecular weight in the range of 22,000 to 50,000, and these vinyl resins have a glass transition temperature (Tg) in the range of 70 to 80° C. These vinyl resins are capable of being softened under high pressure and high temperature conditions at printhead, and solidified at room temperature after ink jetting. These vinyl resins have excellent scratch resistance, and waterfastness, and also have excellent adhesion to PVC substrates, and the strength of the resin film formed on PVC substrates is great. Therefore, UCAR™ solution vinyl resins will be the best choice to be used in the inkjet ink composition because 80% or more of the substrate used in printing are made of PVC, or coated with PVC.

Examples of the resins used in the inkjet ink composition of the present invention include, but are not limited to, UCAR™ solution vinyl resins available from Dow Chemical Company, i.e. vinyl chloride/vinyl acetate copolymer under trade names: VYHH, VYNS-3, VYNC-P, and VYLF-X; carboxyl-modified vinyl copolymer under trade names: VMCH, and VMCA; hydroxyl-modified vinyl copolymer under trade names: VAGD, VAGF, VAGC, VAGH, and VROH; and epoxy-modified vinyl copolymer under trade name VERR-40. These resins can be used singly or in mixture of two or more thereof depending on the desired scratch resistance, waterfastness, and brightness of the ink.

With respect to the surfactants, the surfactants are used to reduce the surface tension of the inkjet ink composition so that the ink can have good covering capabilities. The amount of surfactants used is 0.1% to 1.0% by weight based on the total weight of the inkjet ink composition. The surfactants can be divided into four groups, according to their ionic nature—anionics, cationics, nonionics and amphoterics, and most of them are hydrocarbon, fluorocarbon, or silicone compounds. The surfactant molecules are amphiphilic molecules which can arrange themself at the surface of the liquid such that the polar parts interacts with the liquid and the non-polar parts are held above the surface (in the air). The presence of these molecules on the surface disrupts the cohesive energy at the surface, and thus lowers the surface tension. Generally, a substrate surface has surface energy (mN/m). Examples of the common used substrates include polyesters (43 mN/m), polyethylene (36 mN/m), polypropylene (30 mN/m), and paraffin wax (26 mN/m). The surface tension of the ink should be lower than that of the substrate in order to make the ink have good covering capabilities. The non-toxic polymeric wetting agents used in the inkjet ink composition of the present invention include Perenol® series leveling agents, manufactured by Henkel Corp.; polyether siloxane copolymer in TEGO® WET series, manufactured by TEGO Corp.; EFKA®-73 leveling agents containing silicon, manufactured by EFKA Corp.; or GE silicones in Coatosil® series, manufactured by Crompton Corp. These above-mentioned wetting agents can reduce the surface tension of the ink to 20-40 (mN/m), allowing better coverage on the PVC substates, and can reduce the bubble generation to prevent the nozzle from overheating which can cause its damage.

Examples of the surfactants added singly or in mixture in the present invention include, but are not limited to, polyether siloxane copolymer under trade names:TEGO® Wet 245, Wet 250, Wet 260, Wet 265, Wet 270, and Wet 280; Copolyacrylate under trade names: Perenol® F3, F40, F41, and F45; polysiloxane copolymer under trade names: Perenol® S4, and S43; silicone wetting agent under trade names: CoatOsil® 1211, 1300, 1706, 1757, 1770, 2400, 2810, 3500, 3501, 3503, 3505, 3509, and 3573; and organically modified polysiloxane under trade names: EFKA®-7310, 7311, 7315, 7316, 7340, 7361, 7375, 7381, and 7390.

With respect to the pigments, examples of the organic pigments include, but are not limited to, Yellow 1, Yellow 3, Yellow 12, Yellow 13, Yellow 14, Yellow 17, Yellow 65, Yellow 73, Yellow 74, Yellow 75, Yellow 81, Yellow 83, Yellow 97, Yellow 126, Yellow 127, Yellow 139, Yellow 150, Yellow 151, Yellow 154, Yellow 174, Yellow 176, Yellow 180, Yellow 183, Yellow 188, Orange 5, Orange 13, Orange 16, Orange 34, Orange 36, Red 2, Red 3, Red 4, Red 8, Red 9, Red 12, Red 14, Red 21, Red 22, Red 23, Red 31, Red 48:1, Red 48:2, Red 48:3, Red 48:4, Red 49:1, Red 49:2, Red 52:1, Red 52:2, Red 53:1, Red 53:3, Red 57:1, Red 63:1, Red 81, Red 112, Red 122, Red 144, Red 146, Red 166, Red 170, Red 171, Red 175, Red 176, Red 177, Red 179, Red 184, Red 185, Red 208, Red 210, Red 243, Red 266, Violet 1, Violet 3, Violet 19, Violet 23, Violet 27, Blue 1, Blue 15:1, Blue 15:2, Blue 15:3, Blue 15:4, Blue 56, Blue 61, Green 7, and Black 7. Examples of the inorganic pigments include, not limited to, Pigment Yellow 32, Pigment Yellow 34, Pigment Yellow 36, Yellow 42, Pigment Red 101, Pigment Red 104, Pigment Blue 27, Pigment Pigment Green 17, Pigment Black 11, and Pigment Orange 21.

The polyethylene glycol ether solvents used in the inkjet ink composition of the present invention have a formula of R₁—O(CH₂CH₂O)ₙ—R₂, where R₁ and R₂ are each independently alkyl groups having 1 to 4 carbon atoms, and n is an integer from 2 to 5. The boiling point of the polyethylene glycol ether solvents are 180 to 280° C., and they can be used singly or in mixture of two or more thereof depending on the desired boiling point and the solubility of the inkjet ink composition. The acetoacetate solvents used in the inkjet ink composition of the present invention have a formula of CH₃COCH₂COOR₃ where R₃ is alkyl group having 1 to 4 carbon atoms, and the acetoacetate solvents can be used singly or in mixture of two or more thereof depending on their order and solubility, and the corrosive strength to the printing substrate.

Several different printers with piezo printheads are used in the present invention. These printers include Roland SJ-745 EX, Mimaki JV3-160 SP, and Mutoh RH-II K Plus, and the printing modes are 1400×1400 dpi-16 pass, 1080×1080 dpi-8 pass, 720×720 dpi-8 pass, 360×720 dpi-4 pass, 360×450 dpi-2 pass, 360×360 dpi-1 pass; the piezo printhead include Mutoh 2216 Spectra 256, and the printing mode is 360×360 dpi-4 pass; the piezo printhead include Infiniti 8250 XAAR 128, and the printing mode is 200 dpi-2 pass.

Many different kinds of printing substrates can be used in the present invention. These printing substrates include Solvent Glossy PP Paper, Solvent Luster PP Paper, Solvent Luster Vinyl Paper, Solvent Glossy Vinyl Paper, Solvent Photo Paper, Art Canvas, Canvas, and Mesh Vinyl Paper.

The following examples are presented for illustrative purposes only, and not intended as a restriction on the scope of the invention.

### EXAMPLE 1

The inkjet ink composition, according to this embodiment, are prepared by mixing the components mentioned in Table 1, in the proportions indicated. This inkjet ink composition is suitably applied in EPSON™ printhead.

TABLE 1

| Components | Content (percentage by weight) |
|---|---|
| Red pigment | 25% |
| Surfactant | 0.2% |
| Polyethylene glycol ether solvent | 43.3% |
| Acetoacetate solvent | 30% |
| Resin | 1.5% |
| total | 100% |

The viscosity of the inkjet ink composition in Table 1 is measured on a Brookfield DV-E model Digitial Viscometer at 25° C. The surface tension is measured on a CBVP-A3 tensionmeter, manufactured by Kyowa. Kaimenkagaku Co., Ltd. The chromaticity coordinate graph is measured on a Nippon Denshoku's spectrophotometer (SA 2000) operated in L* a* b* color space. L*, a*, and b* denote psychometric lightness, psychometric hue, and psychometric chroma coordinates, respectively. The pH value is measured with a calibrated pH meter. The alcohol resistance test is carried out by rubbing the inked pattern with 99.5% ethanol-soaked cotton stick for 5 passes, and then whether the rubbed inked pattern has been discolored is examined visually. The scratch resistance test is carried out by scratching the inked pattern with an HB pencil for 10 passes, and then the pencil lines are erased to observe whether any scratch has been made on the inked pattern. The brightness of ink on the printing substrate is examined visually, and the substrate for specialty printing is glossy PVC, such as Solvent Glossy Vinyl.

The suitable printhead, viscosity, surface tension, chromaticity coordinates, pH value, alcohol resistance, scratch resistance, and brightness test results for the inkjet ink composition in Table 1 are listed in Table 5.

### EXAMPLE 2

The inkjet ink composition, according to this embodiment, are prepared by mixing the components mentioned in Table 2, in the proportions indicated. This inkjet ink composition is suitably applied in XAAR™ 126/128 printhead.

TABLE 2

| Components | Content (percentage by weight) |
|---|---|
| Red pigment | 23% |
| Surfactant | 0.2% |
| Polyethylene glycol ether solvent | 33.8% |
| Acetoacetate solvent | 40% |
| Resin | 3.0% |
| total | 100% |

The same viscosity, surface tension chromaticity coordinates, pH value, alcohol resistance, scratch resistance, and brightness tests as EXAMPLE 1 are repeated for the inkjet ink composition in Table 2, and the test results are listed in Table 5.

### EXAMPLE 3

The inkjet ink composition, according to this embodiment, are prepared by mixing the components mentioned in Table 3, in the proportions indicated. This inkjet ink composition is suitably applied in XAAR™ 500 printhead.

TABLE 3

| Components | Content (percentage by weight) |
|---|---|
| Red pigment | 28% |
| Surfactant | 0.2% |
| Polyethylene glycol ether solvent | 31.8% |
| Acetoacetate solvent | 36% |
| Resin | 4.0% |
| total | 100% |

The same viscosity, surface tension, chromaticity coordinates, pH value, alcohol resistance, scratch resistance, and brightness tests as EXAMPLE 1 are repeated for the inkjet ink composition in Table 3, and the test results are listed in Table 5.

### EXAMPLE 4

The inkjet ink composition, according to this embodiment, are prepared by mixing the components mentioned in Table 4, in the proportions indicated. This inkjet ink composition is suitably applied in Spectra™ 128/256 printhead.

TABLE 4

| Components | Content (percentage by weight) |
|---|---|
| Red pigment | 30% |
| Surfactant | 0.2% |
| Polyethylene glycol ether solvent | 32% |
| Acetoacetate solvent | 33.3% |
| Resin | 4.5% |
| total | 100% |

The same viscosity, surface tension, chromaticity coordinates, pH value, alcohol resistance, scratch resistance, and brightness tests as EXAMPLE 1 are repeated for the inkjet ink composition in Table 4, and the test results are listed in Table 5.

The suitable printhead, viscosity, surface tension, chromaticity coordinates, pH value, alcohol resistance, scratch resistance, and brightness test results for the inkjet ink composition respectively prepared from Examples 1, 2,3, and 4 are shown in Table 5.

TABLE 5

| | Example 1 | Example 2 | Example 3 | Example 4 |
|---|---|---|---|---|
| Suitable | EPSON ™ | XAAR ™ | XAAR ™ | Spectra ™ |
| printhead | | (126/128) | (500) | (128/256) |
| Viscosity | 4.31 | 10.24 | 13.21 | 13.56 |
| (cps) | | | | |
| Surface | 29.7 | 31.2 | 29.0 | 32.3 |
| tension | | | | |
| (dyne/cm) | | | | |
| Chromaticity | 38.5, 72.51, | 39.7, 74.09, | 37.7, 71.94, | 36.39, 71.5, |
| coordinates | 5.62 | 4.79 | 6.66 | 10.73 |
| (L*a*b*) | | | | |
| pH value | 7.50 | 7.12 | 7.35 | 7.20 |
| alcohol | − | + | + | + |
| resistance^{(a)} | | | | |
| Scratch | good | excellent | excellent | excellent |
| resistance | | | | |
| Brightness | good | excellent | excellent | excellent |

^{(a)}Alcohol resistance, −: slightly discoloration, −−: badly discoloration, and +: no discoloration.

The viscosity of the inkjet ink composition of the present invention is in the range of 3.0 to 20 cps at ambient temperature, and the surface tension of the inkjet ink composition is in the range of 20 dynes/cm to 40 dynes/cm. In the inkjet ink composition of the present invention, the pigment is present in an amount of from 1 to 40% by weight of the total weight of the inkjet ink composition, the surfactant is present in an amount of from 0.1 to 1.0% by weight of the total weight of the inkjet ink composition, the solvent is present in an amount of from 65 to 90% by weight (inclusive of 20 to 40% by weight of the wetting agent) of the total weight of the inkjet ink composition, and the resin is present in an amount of from 0.5 to 10% by weight of the total weight of the inkjet ink composition.

The present invention provides an environmental-friendly inkjet ink composition which is not carcinogens, and is low toxic to human bodies and livestocks. The environmental-friendly inkjet ink composition is not pungent, and it has excellent scratch resistance and waterfastness, and can guarantee high printing quality. The addition amount of the components depends on the desired ink color, and the specification of the printhead. These components can be used singly or in mixture of two or more thereof. The inkjet ink composition of the present invention can be applied in various kinds of piezo printers, and can be printed on various kinds of the printing substrates.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. An inkjet ink composition, comprising at least one pigment, at least one surfactant, at least one polyethylene glycol ether solvent, at least one acetoacetate solvent, and at least one resin.

2. The composition as claimed in claim 1, wherein the pigment is present in an amount of from 1 to 40% by weight of the total weight of the inkjet ink composition, the surfactant is present in an amount of from 0.1 to 1.0% by weight of the total weight of the inkjet ink composition, the polyethylene glycol ether solvent is present in an amount of from 30 to 60% by weight of the total weight of the inkjet ink composition, the acetoacetate solvent is present in an amount of from 20 to 40% by weight of the total weight of the inkjet ink composition, and the resin is present in an amount of from 0.5 to 10% by weight of the total weight of the inkjet ink composition.

3. The composition as claimed in claim 1, wherein the the surfactant contains silicon.

4. The composition as claimed in claim 1, wherein the the surfactant does not contain silicon.

5. The composition as claimed in claim 1, wherein the polyethylene glycol ether solvent has a formula of R₁—O(CH₂CH₂O)ₙ—R₂, where R₁ and R₂ are each independently alkyl groups having 1 to 4 carbon atoms, and n is an integer from 2 to 5.

6. The composition as claimed in claim 1, wherein the acetoacetate solvent has a formula of CH₃COCH₂COOR₃ where R₃ is alkyl group having 1 to 4 carbon atoms.

7. The composition as claimed in claim 1, wherein the surfactant is selected from the group consisting of polyether sitoxane copolymer, copolyacrylate, polysiloxane copolymer, silicone wetting agent, and organically modified polysiloxane.

8. The composition as claimed in claim 1, wherein the resin is selected from the group consisting of vinyl chloride/vinyl acetate copolymer, carboxyl-modified vinyl copolymer, hydroxyl-modified vinyl copolymer, and epoxy-modified vinyl copolymer.

9. The composition as claimed in claim 1, wherein a boiling point of the polyethylene glycol ether solvent is 180 to 280° C.

10. The composition as claimed in claim 1, wherein the resin has a molecular weight in the range of 22,000 to 50,000, and the resin has a glass transition temperature in the range of 70 to 80° C.

11. The composition as claimed in claim 1, wherein a viscosity of the inkjet ink composition is in the range of 3.0 to 20 cps at ambient temperature, and a surface tension of the inkjet ink composition is in the range of 20 to 40 dynes/cm.

12. A low-toxic and non-pungent inkjet ink composition, comprising at least one pigment, at least one surfactant, at least one polyethylene glycol ether solvent, at least one acetoacetate solvent, and at least one resin.

13. The composition as claimed in claim 12, wherein the pigment is present in an amount of from 1 to 40% by weight of the total weight of the inkjet ink composition, the surfactant is present in an amount of from 0.1 to 1.0% by weight of the total weight of the inkjet ink composition, the polyethylene glycol ether solvent is present in an amount of from 30 to 60% by weight of the total weight of the inkjet ink composition, the acetoacetate solvent is present in an amount of from 20 to 40% by weight of the total weight of the inkjet ink composition, and the resin is present in an amount of from 0.5 to 10% by weight of the total weight of the inkjet ink composition.

14. The composition as claimed in claim 12, wherein the the surfactant contains silicon.

15. The composition as claimed in claim 12, wherein the the surfactant does not contain silicon.

16. The composition as claimed in claim 12, wherein the polyethylene glycol ether solvent has a formula of R₁—O(CH₂CH₂O)ₙ—R₂, where R₁ and R₂ are each independently alkyl groups having 1 to 4 carbon atoms, and n is an integer from 2 to 5.

17. The composition as claimed in claim 12, wherein the acetoacetate solvent has a formula of CH₃COCH₂COOR₃, where R₃ is alkyl group having 1 to 4 carbon atoms.

18. The composition as claimed in claim 12, wherein the surfactant is selected from the group consisting of polyether siloxane copolymer, copolyacrylate, polysiloxane copolymer, silicone wetting agent, and organically modified polysiloxane.

19. The composition as claimed in claim 12, wherein the resin is selected from the group consisting of vinyl chloride/vinyl acetate copolymer, carboxyl-modified vinyl copolymer, hydroxyl-modified vinyl copolymer, and epoxy-modified vinyl copolymer.

20. The composition as claimed in claim 12, wherein a boiling point of the polyethylene glycol ether solvent is 180 to 280° C.

21. The composition as claimed in claim 12, wherein the resin has a molecular weight in the range of 22,000 to 50,000, and the resin has a glass transition temperature in the range of 70 to 80° C.

22. The composition as claimed in claim 12, wherein a viscosity of the inkjet ink composition is in the range of 3.0 to 20 cps at ambient temperature, and a surface tension of the inkjet ink composition is in the range of 20 to 40 dynes/cm.

23. A low-toxic and non-pungent inkjet ink composition, characterized in that it comprises at least one polyethylene glycol ether solvent having a formula of R₁—O(CH₂CH₂O)ₙ—R₂, where R₁ and R₂ are each independently alkyl groups having 1 to 4 carbon atoms, and n is an integer from 2 to 5.

24. A low-toxic and non-pungent inkjet ink composition, characterized in that it comprises at least one acetoacetate solvent having a formula of CH₃COCH₂COOR₃, where. R₃ is alkyl group having 1 to 4 carbon atoms.
